(19) United States
(12) Patent Application Publication
(10) Pub. No.: US 2004/0105742 A1
(43) Pub. Date: Jun. 3, 2004

(54) Semiconductor manufacturing system

(76) Inventors: Seung-Kap Park, Suwon-City (KR); Jeong-Ho Yoo, Suwon-City (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/334,797

(22) Filed: Jan. 2, 2003

(30) Foreign Application Priority Data
Nov. 30, 2002 (KR) 2002-75643

(51) Int. Cl. B65G 49/07

(52) U.S. Cl. 414/416.01

(57) ABSTRACT

Provided is a semiconductor manufacturing system. The semiconductor manufacturing system includes a wafer loading boat, a complementary wafer loading boat, a door assembly, and a spacing controlling system. The wafer loading boat is mounted in the reaction tube and includes a plurality of wafer supporters on which the semiconductor wafer is rested on. The complementary wafer loading boat is located inside or outside of the wafer loading boat, moves vertically, includes a wafer holder that is devised to support the semiconductor wafer. The contact between the wafer and the holder in the center part of the wafer other than edges of the wafer is adjusted by moving one of the wafer loading boats vertically. The spacing controlling system is mounted in the door assembly, controls a space between the semiconductor wafer and the wafer holder, and maintains or adjusts a contact area of the semiconductor wafer with the wafer holder dynamically during the thermal processing. Thus, the mechanical deformation including warping, bowing, slip can be completely eliminated by supporting the wafer in the center part of the wafer with controlled contact area, resulting from ideal distribution of the gravitational force of the wafer. Also the reliability, uniformity and reproducibility of the thermal processing steps can be significantly enhanced due to the ability to control the gap between the wafer and the holder, and to control the contact area between the wafer and the holder dynamically even during the process at high temperatures, which has been never possible in the previous arts. In addition, it is possible to perform the thermal process without any mechanical damages to the semiconductor wafer having a diameter of 300 mm (12 inches) or greater.

### BACKGROUND OF THE INVENTION

This application claims the priority of Korean Patent Application No. 2002-75643, filed on Nov. 30, 2002, in the Korean Intellectual Property Office, the disclosure of which is incorporated herein in its entirety by reference.

1. Field of the Invention

The present invention relates to a semiconductor manufacturing system, and more particularly, to a semiconductor manufacturing system having a wafer loading boat by which a plurality of semiconductor wafers can be processed at a time.

2. Description of the Related Art

In general, a semiconductor manufacturing system in which a plurality of semiconductor wafers can be processed includes a wafer loading boat for loading the semiconductor wafers. The wafer loading boat comprises a plurality of supporting pillars which are arranged to form an accommodating space in a shape of a cylinder inside the wafer loading boat, an upper supporting board and a lower supporting board on which both ends of the supporting pillars are fixed. In the supporting pillars, slots are formed at vertical interval for supporting the semiconductor wafer. Thus, edges of the semiconductor wafer are then at least partially fitted in the slots and can be loaded horizontally. In order to minimize the contact area of the semiconductor wafer with the slots, there have been many attempts such as one where the slots are inclined upwardly at a predetermined angle with the semiconductor wafers. Thus, any defect such as mechanical deformation in a form of warp, bow and slip in the semiconductor wafer is prevented from occurring during the thermal process at high temperatures.

However, as the diameter of the semiconductor wafer increases above 200 mm (8 inches), the center of the semiconductor wafer is seriously warped or bowed downwardly during the thermal process due to the gravitational force of the wafer at a high temperature more than 900° C. Thus, a degree of such curvature exceeds an elasticity limit, resulting in mechanical deformation of the wafer after completion of the thermal process. Therefore, such warping or bowing causes many problems to a silicon substrate of the semiconductor wafer.

### SUMMARY OF THE INVENTION

To solve the above-described and related problems, it is an object of the present invention to provide a semiconductor manufacturing system capable of preventing any mechanical deformation such as warping, bowing, and slip in a semiconductor wafer having a large diameter during a thermal process, thereby preventing any defect in the semiconductor wafer.

The present invention also provides a reliable semiconductor manufacturing system even if both flatness and surface roughness of a semiconductor wafer are not sufficiently good enough, thereby enhancing reliability of the thermal processing system.

In an aspect, the present invention provides a semiconductor manufacturing system having a reaction tube capable of performing a thermal process comprising dual boats inside the reaction tube;

a wafer loading boat, which is mounted in the reaction tube, forms an accommodating space in a shape of a cylinder, and includes a plurality of wafer supporters on which the semiconductor wafer is rested on,

a complementary wafer loading boat which is located inside or outside of the wafer loading boat within the reaction tube, includes a wafer holder supporter on which the wafer holder is rested on, where the wafer holder is devised to support the semiconductor wafer with at least a part of area in the middle of the wafer holder, where the wafer holder contacts the semiconductor wafer either at room temperature before processing or during high temperature processing, where the contact between the wafer and the holder at high temperatures can be achieved naturally by placing the wafer holder adjacent to the wafer beneath at room temperature when the semiconductor wafer bows within the elastic limit at high processing temperatures, and transfers a weight loaded to the wafer to its lower portion of the wafer holder,

a door assembly which supports lower portions of the wafer loading boat and the complementary wafer loading boat, moves the wafer loading boat and the complementary wafer loading boat, and closes the reaction tube,

and a spacing controlling system which is mounted in the door assembly, controls a space between the wafer loading boat and the complementary loading boat, which eventually controls the spacing between the semiconductor wafer and the wafer holder, maintains a contact area of the semiconductor wafer with the wafer holder, and dynamically controls the gap between the wafer and wafer holder during thermal processing.

Here, the wafer loading boat comprises a plurality of supporting pillars which are arranged in parallel with each other to form an accommodating space in a shape of a cylinder, an upper board and a lower board which respectively fixes the supporting pillars at the same level, and a wafer supporter which is formed in the supporting pillars at a vertical interval and on which the semiconductor wafer is loaded horizontally. Here, one sidewall of the supporting pillars is opened, and the number of the supporting pillars is at least one forming a cylindrical shape. Thus, at least one supporting point can be obtained. A section of the supporting pillars may have a polygonal shape.

The wafer supporter may be a protrusion protruded at a right angle with respect to the supporting pillars or a slot formed by grooving the supporting pillars.

The complementary wafer loading boat comprises a plurality of complementary supporting pillars which are arranged at a predetermined interval to form an accommodating space in a shape of a cylinder inside or outside the wafer loading boat, and a wafer holder which is extended from the complementary supporting pillars to support the semiconductor wafer by making contact with at least a part other than both edges of the semiconductor wafer either at room temperature or during thermal processing by adjusting the gap between the wafer and wafer holder dynamically. It is desirable that the number of the complementary supporting pillars is at least one to form a cylindrical space.

Here, the wafer holder has a shape of a plate on which the semiconductor wafer is rested, and the holder supporter is formed in the complementary supporting pillars to load the wafer holder horizontally at a vertical interval. The wafer holder includes a plurality of opening portions which are extended from the edge of the wafer holder toward a center of the wafer holder at a predetermined length and shape, thus the wafer supporters and pillars in the wafer loading boat can move through the wafer holder freely. Here, the holder supporter may be a slot formed by grooving the complementary supporting pillars or a protrusion type protruded from the complementary supporting pillars toward the accommodating space of the complementary wafer loading boat.

The spacing controlling system comprises at least one weight sensor which supports at least a lower portion of the wafer loading boat and the complementary wafer loading boat and senses a weight of at least one of the wafer loading boat and the complementary wafer loading boat, a boat lifting driver which is connected to at least either the wafer loading boat or the complemetary wafer loading boat and lifts or moves vertically the loading boat connected to the boat lifting driver, and a space control part which is connected to the weight sensor, compares the sensed weight to a setting point and controls the boat lifting driver.

It is preferable that the weight sensor be formed by using piezoelectric devices to sense a fine weight.

It is preferable that the boat lifting driver moves electrically by a method of fine controlling of a motor, or hydraulically by a fluid pressure to guarantee accuracy and flexibility of operations of the boat lifting driver.

It is preferable that the weight sensor and the boat lifting driver are electrically connected in series in the space control part to control operations of the boat lifting driver by a signal from the weight sensor.

The semiconductor manufacturing system according to the present invention includes dual boats having a wafer loading boat in which the semiconductor wafer can be loaded and a complemetary wafer loading boat in which the wafer holder can be loaded to support the semiconductor wafer during processing by sensing a change in a weight of the wafer loading boat or complementary wafer loading boat. Thus, it is possible to perform the thermal process without any mechanical deformation of the semiconductor wafer having a large diameter by dynamically controlling the contact area of the semiconductor wafer with the wafer holder.

In addition, a reaction gas is uniformly distributed to the semiconductor wafer by controlling the contact area. Therefore, uniformity in a semiconductor manufacturing process can be improved.

### BRIEF DESCRIPTION OF THE DRAWINGS

The above object and advantages of the present invention will become more apparent by describing in detail-preferred embodiments thereof with reference to the attached drawings in which:

FIG. 1A is a schematic sectional view of a semiconductor manufacturing system according to the present invention;

FIG. 1B is a sectional view showing FIG. 1A in more detail according to one embodiment of the present invention;

FIG. 2 is an enlarged sectional view of a lower structure of a wafer loading boat and complementary wafer loading boat according to the present invention;

FIG. 3A is a sectional view of a wafer loading boat and a complementary wafer loading boat mounted in a semiconductor manufacturing system of the present invention;

FIG. 3B is a sectional view showing a combination of a wafer loading boat and a complementary wafer loading boat of FIG. 3A;

FIG. 4A is a sectional view showing a semiconductor wafer which is loaded in a wafer loading boat of the present invention;

FIG. 4B is a sectional view showing a semiconductor wafer during a thermal process at a high temperature;

FIG. 5 is an enlarged sectional view of a door assembly which includes a spacing controlling system mounted in a semiconductor manufacturing system according to one embodiment of the present invention;

FIG. 6 is a sectional view of a spacing controlling system mounted in a semiconductor manufacturing system according to another embodiment of the present invention; and

FIGS. 7A and 7B are a schematic control flowchart and a block diagram which are applied to a spacing controlling system for controlling a space of a complementary wafer loading boat and a wafer loading boat.

### DETAILED DESCRIPTION OF THE INVENTION

The present invention will now be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully transfer the concept of the invention to those skilled in the art.

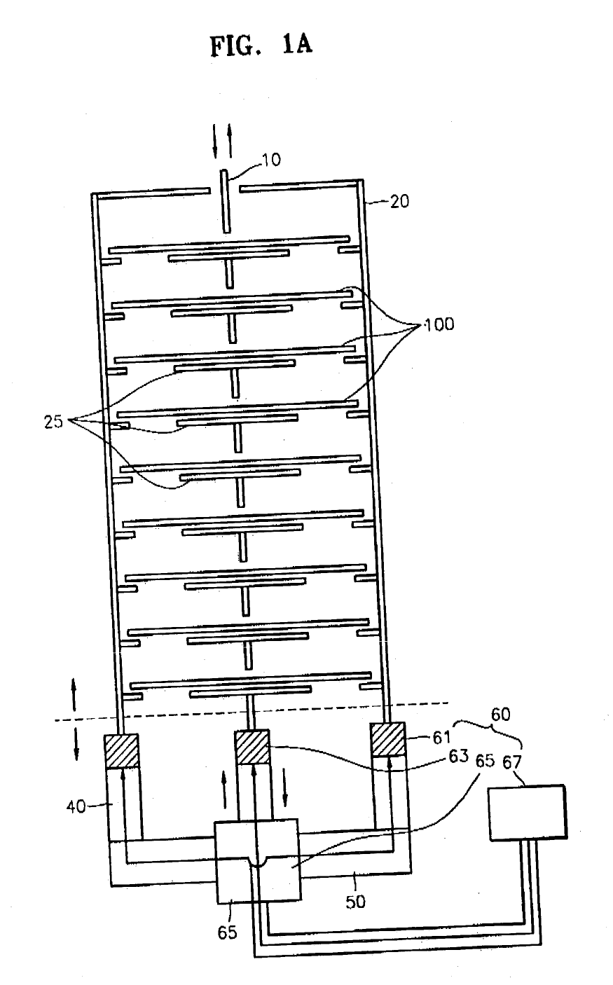

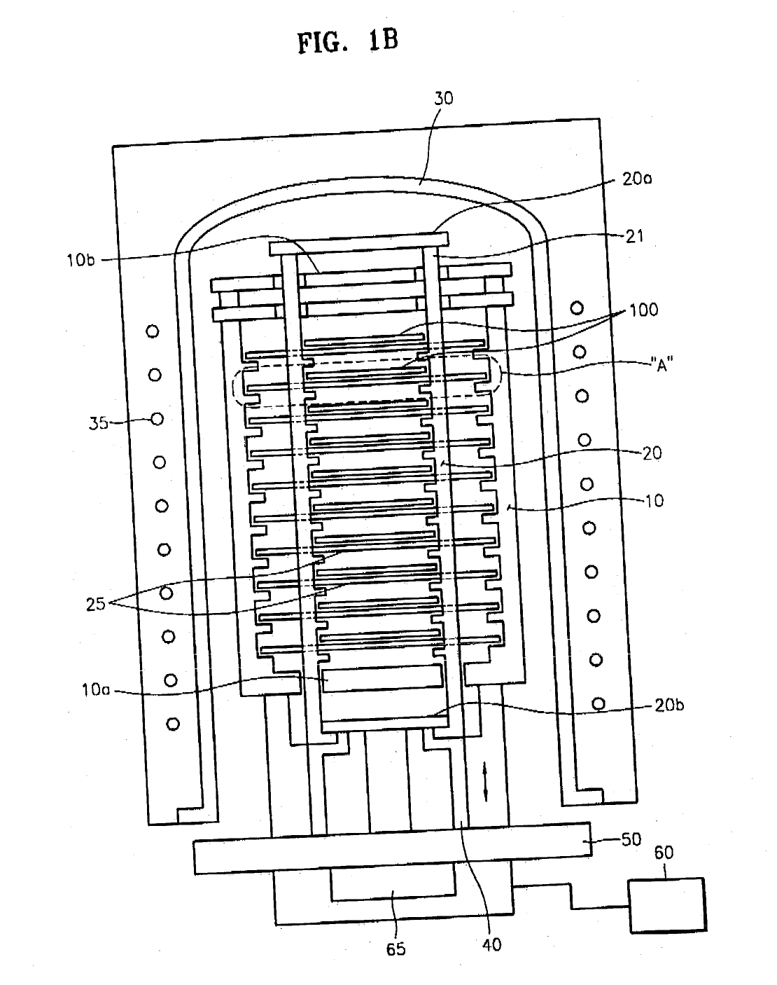

FIG. 1A is a schematic sectional view of a semiconductor manufacturing system according to the present invention to describe concept of the present invention. FIG. 1B is a sectional view showing FIG. 1A in more detail according to one embodiment of the present invention. FIG. 2 is an enlarged sectional view of a lower structure of a wafer loading boat and a complementary wafer loading boat according to the present invention.

Referring to FIGS. 1A and 1B, a semiconductor manufacturing system of the present invention includes a reaction tube 30 which provides an accommodating space used for processing semiconductor wafers 100. A semiconductor wafer loading boat 20, in which the semiconductor wafers 100 are loaded, and a door assembly 50, which supports the lower portion of the wafer loading boat 20, inserts the wafer loading boat 20 in the reaction tube 30 and pulls the wafer loading boat 20 out from the reaction tube 30, are included in the reaction tube 30. In addition, a complementary wafer loading boat 10 is included in the reaction tube 30 and has a wafer holder 25 that is capable of supporting the bottom of the semiconductor wafer 100 loaded in the wafer loading boat 20 with contacting at least a part of the bottom of the semiconductor wafer 100. A spacing controlling system 60 is included in the door assembly 50. The spacing controlling system 60 supports the lower portions of the wafer loading boat 20 and the complementary wafer loading boat 10, senses weights of the wafer loading boat 20 and the complementary wafer loading boat 10, and controls a contact area of the semiconductor wafer 100 with the wafer holder 25 dynamically.

The reaction tube 30 has an opening portion thereunder. A heating element 35 such as a resistance coil, which is capable of heating the reaction tube 30, surrounds the reaction tube 30. Thus, inside of the reaction tube 30 can be heated to a predetermined temperature during the thermal process.

In the opening portion of the reaction tube 30, the door assembly 50 is formed to lift or move downwardly the wafer loading boat 20 and to close the opening portion of the reaction tube 30 during the thermal process.

Referring to FIGS. 1B and 2, the wafer loading boat 20 comprises a plurality of supporting pillars 21 arranged in parallel with each other to form a cylindrical space of which one sidewall is partially opened. Here, a section of the supporting pillars 21 may have a circular shape or a polygonal shape. In the lower and upper portions of the supporting pillars 21, an upper board 20a and a lower board 20b are formed to respectively fix the supporting pillars 21 at the same level. The wafer loading boat 20 is fixed in the door assembly 50 through a boat cap 40 whose lower portion has a supporting structure.

The complementary wafer loading boat 10 may be formed outside or inside the wafer loading boat 20. Here, the complementary wafer loading boat 10 is outside the wafer loading boat 20. That is, a plurality of complementary supporting pillars 11 are arranged in parallel with the supporting pillars 21 and forms a cylindrical space of which one sidewall is opened outside the cylindrical space formed by the supporting pillars 21. In the lower and upper portions of the complementary supporting pillars 11, a complementary upper board 10a and an complementary lower board 10b are formed to respectively fix the complementary supporting pillars 11 at the same level. Further, the wafer holder 25 is extended to the complementary supporting pillars 11 so that it can support the bottom of the semiconductor wafer 100 loaded in the wafer loading boat 20.

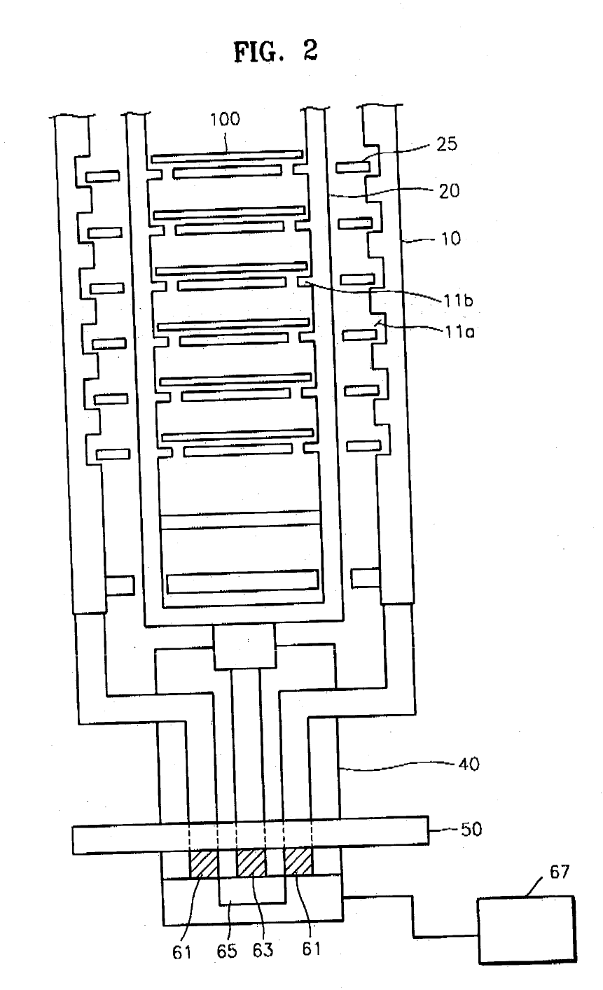

FIGS. 3A and 3B are enlarged sectional views of portion ‘A’ of FIG. 1A for explaining the wafer loading boat 20 and the complementary wafer loading boat 10 in more detail. Here, FIG. 3A is a sectional view of the wafer loading boat 20 and the complementary wafer loading boat 10, and FIG. 3B is a sectional view showing a combination of the wafer loading boat 20 and the complementary wafer loading boat 10 of FIG. 3A.

Referring to FIG. 3A, a wafer supporter 21a is formed at the supporting pillars 21 at a predetermined vertical interval to support the semiconductor wafer 100 horizontally in both edges of the semiconductor wafer 100. The wafer supporter 21a is formed in a shape of a slot type by grooving the supporting pillars 21 toward the accommodating space so that the semiconductor wafer 100 can be supported horizontally (hereinafter, the wafer supporter 21a is also referred to as the slot with the same reference numeral). Thus, a plurality of semiconductor wafers 100 can be loaded by resting the semiconductor wafer 100 on the slot 21a.

The complementary wafer loading boat 10 includes a wafer holder as the wafer holder 25 to support at least a part of the bottom of the semiconductor wafer 100 (hereinafter, the wafer holder 25 is also referred to as the wafer holder with the same reference numeral). A holder supporter 11a is formed in the complementary supporting pillars 11 to support the wafer holder 25 in edges of the wafer holder 25. The holder supporter 11a may be in a shape of a slot type by grooving the complementary supporting pillars 11 toward the accommodating space of the complementary wafer loading boat 10. The holder supporter 11a may be in a shape of a protrusion type protruded at a right angle with respect to the complementary supporting pillars 11 toward the accommodating space of the complementary wafer loading boat 10. Here, the wafer holder 25 includes an opening portion (not shown) which is formed to correspond to the supporting pillars 21 so that the wafer loading boat 20 can be vertically lifted at a predetermined height from the complementary wafer loading boat 10. Here, the opening portion (not shown) is extended from the center of the wafer holder 25 to a circumference of the wafer holder 25. The opening portion (not shown) may have various shapes.

Referring to FIG. 3B, the semiconductor wafer 100 is loaded in the wafer loading boat 20. When the semiconductor wafer 100 is loaded in the wafer loading boat 20 for start of the thermal process, center portions and edges of the semiconductor wafer 100 is rested on the wafer holder 25, and edges of the semiconductor wafer 100 are supported by the wafer supporter 21a. Thus, a weight of the semiconductor wafer 100 is distributed to two parts, i.e., the wafer loading boat 20 and the complementary wafer loading boat 10.

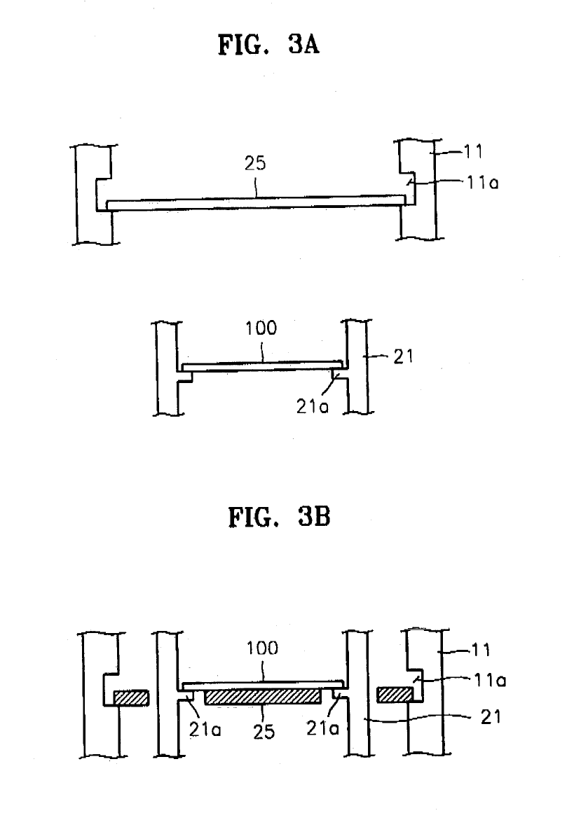

FIGS. 4A and 4B are sectional views showing the semiconductor wafers prior to the thermal process and during the thermal process. Here, hatched portions are related to the complementary wafer loading boat 10, and unhatched portions are related to the wafer loading boat 20. The weight of the semiconductor wafer 100 is distributed to both the wafer loading boat 20 and the complementary wafer loading boat 10 through the wafer holder 25 and the wafer supporter 21a.

Referring to FIG. 4A, when the semiconductor wafer 100 is loaded in the wafer loading boat 20, the semiconductor wafer 100 holds its equilibrium, and the weight of the semiconductor wafer 100 is distributed to the wafer supporter 21a and the wafer holder 25. That is, the weight loaded to the complementary wafer loading boat 10 includes weights of the complementary wafer loading boat 10, the wafer holder 25 and the center portions of the semiconductor wafer 100. The weight loaded to the complementary wafer loading boat 10 includes weights of the wafer loading boat 20 and edges of the semiconductor wafer 100 which are rested on the wafer supporter 21a.

Referring to FIG. 4B, if the semiconductor wafer 100 is exposed to a high temperature of about 900° C. through 1350° C. during the thermal process, the semiconductor wafer 100 is expanded, and the center portions of the semiconductor wafer 100 is curved downwardly due to gravity and flowing of its silicon substrate. Thus, a partial weight is applied to the center portions of the wafer holder 25 due to such curvature of the semiconductor wafer 100. The weight loaded to the complementary wafer loading boat 10 in which the wafer holder 25 is loaded increases, and thus a change increase in the weight loaded in the complementary wafer loading boat 10 occurs. Such change in the weight is sensed by the spacing controlling system 60, and the spacing controlling system 60 controls the space between the semiconductor wafer 100 and the wafer holder 25 according to the sensed weight. That is, if the change in the weight is sensed, the spacing controlling system 60 moves the wafer holder 25 downwardly or upwardly with respect to the wafer supporter 21a. Then, an additional weight of the wafer holder 25 is transferred to the wafer supporter 21a, and then the weight turns to the weight of the semiconductor wafer 100 in its horizontal position. In contrast to this case, if the semiconductor wafer 100 is shrank at a low temperature, thus it turns to its original state, the weight of the complementary wafer loading boat 10 is reduced. Thus, the spacing controlling system 60 lifts the wafer holder 25 such that the weight of the complementary wafer loading boat 10 turns to the weight of the semiconductor wafer 100 in its horizontal position. As mentioned below, the spacing controlling system 60 drives a boat lifting driver dynamically to keep the contact area constant during thermal process.

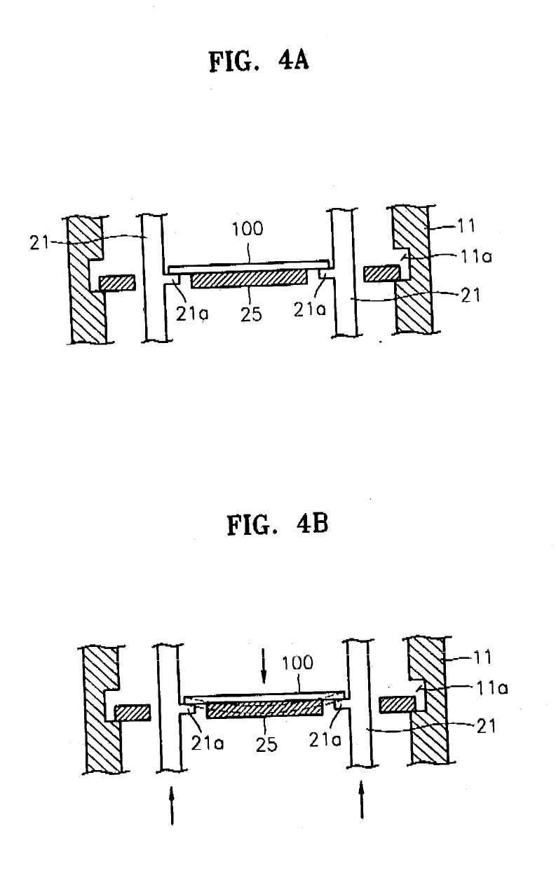

FIG. 5 is an enlarged sectional view of the wafer loading boat 20 and the door assembly 50 for explaining the spacing controlling system 60 mounted in the semiconductor manufacturing system according to the present invention.

Referring to FIG. 5, the spacing controlling system 60 includes the boat cap 40, which supports the lower portion of the wafer loading boat 20, and a first weight sensor 61 which is extended to outside the door assembly 50 through the boat cap 40 to transfer the weight loaded to the wafer loading boat 20 to the lower portion of the wafer loading boat 20, supports the lower portion of the wafer loading boat 20 and senses a change in the weight loaded to the wafer loading boat 20. The spacing controlling system 60 also includes a second weight sensor 63 which is extended to outside the door assembly 50 through a structure included in the boat cap 40 to transfer the weight loaded to the complementary wafer loading boat 10 to the lower portion of the complementary wafer loading boat 10, supports the lower portion of the complementary wafer loading boat 10 and senses a change in the weight of the complementary wafer loading boat 10. Here, it is desirable that the first weight sensor 61 and the second weight sensor 63 be formed by using piezoelectric devices to control a electrical signal according to the change in the weight loaded in the wafer loading boat 20 or the complementary wafer loading boat 10. Here, the lower portion of the complementary wafer loading boat 10 is fixed on a surface of the door assembly 50. In the lower portion of the wafer loading boat 20, a boat lifting driver 65 is connected to the wafer loading boat 20, moves vertically the wafer loading boat 20 and controls dynamically the space between the wafer holder 25 and wafer supporter 21 a or the semiconductor wafer 100. A spacing control part 67 is electrically connected to the first weight sensor 61, the second weight sensor 63 and the boat lifting driver 65 to receive and computerize a signal sensed by the first and the second weight sensors 61 and 63, and controls the boat lifting driver 65. Here, the boat lifting driver 65 is dynamically operated on the basis of a difference between the weights sensed by the first and the second weight sensors 61 and 63.

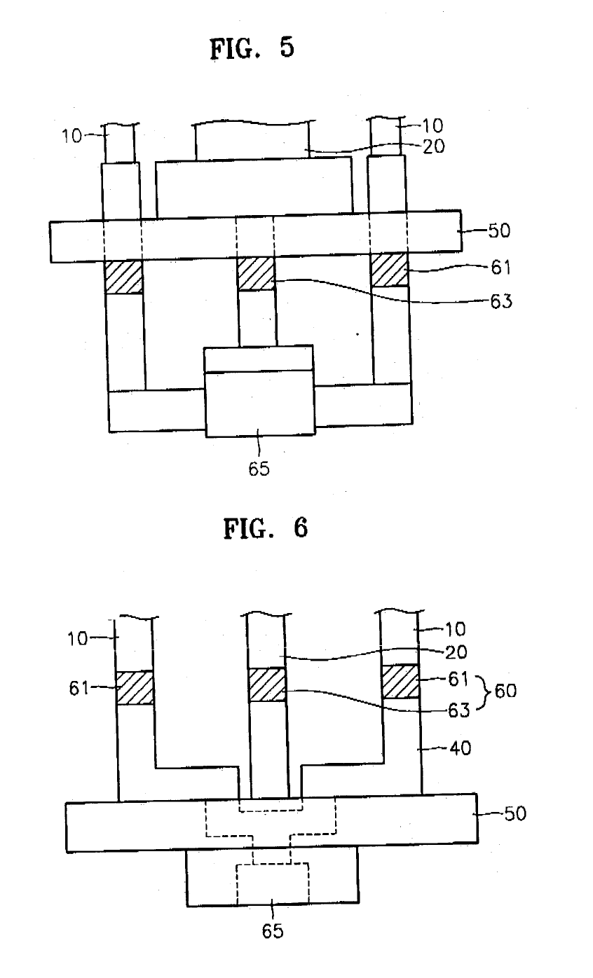

FIG. 6 is a sectional view of a spacing controlling system mounted in a semiconductor manufacturing system according to another embodiment of the present invention. Here, the first and the second weight sensors 61 and 63 can be inside or outside the door assembly 50. In this case, the first and the second weight sensors 61 and 63 of the spacing controlling system 60 are inside the door assembly 50.

Referring to FIG. 6, the boat lifting driver 65 is connected to the lower portion of the complementary wafer loading boat 10 in contrast to FIG. 5. Thus, the complementary wafer loading boat 10 can move vertically. When the semiconductor wafer 100 is curved downwardly, thus the weight loaded to the complementary wafer loading boat 10 increases, the complementary wafer loading boat 10 is lifted to reduce the weight loaded to the wafer loading boat 20 also.

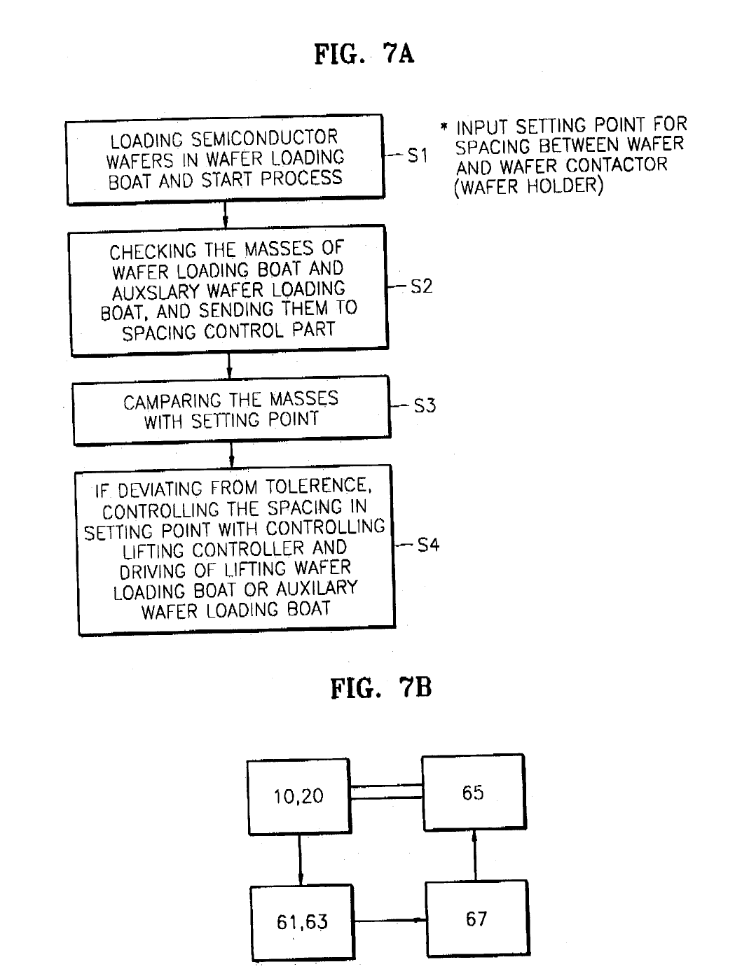

FIGS. 7A and 7B are a control flowchart and a block diagram showing a control of the contact area of the semiconductor wafer 100 with the wafer holder 25 by controlling the space between the wafer holder 25 and the wafer supporter 21a or semiconductor wafer 100 of a semiconductor manufacturing system according to the present invention.

Referring to FIGS. 7A and 7B, after the semiconductor wafer 100 is loaded in the wafer loading boat 20 and is inserted into the reaction tube 30, a recipe file having a setting point for spacing between the semiconductor wafer 100 and the wafer holder or the wafer holder is loaded and the thermal process starts (step S1). Then, the first and the second weight sensors 61 and 63 start to sense a weight and transfer the weight signal to the space control part 67 (step S2). The sensed weight is compared to the setting point, and the difference between the sensed weight and the setting point are calculated (step S3). If the difference is not within a range of tolerance, the wafer loading boat 20 or the complementary wafer loading boat 10 are lifted or move downwardly at a predetermined height by sending a signal to the boat lifting driver 65 (step S4). Here, the setting point may be presented as an electric setting point such as an electric current and voltage value or a real weight by the unit of gram or kilogram. Further, the setting point may be a weight loaded to the wafer loading boat 20 and the complementary wafer loading boat 10, or the difference between the weights of the wafer loading boat 20 and the complementary wafer loading boat 10. In general, the setting point for control is the difference between the weights loaded to the wafer loading boat 20 and the complementary wafer loading boat 10.

The thermal process is performed as follows.

A temperature inside the reaction tube 30 is ramped up by the heating element 35 up to 900° C. to 1350° C. After the semiconductor wafer 100 is exposed to an environment at a high temperature, the semiconductor wafer 100 is expanded, and a silicon substrate of the semiconductor wafer 100 has a flowing characteristic. Then, the semiconductor wafer 100 is curved downwardly by gravity, thus the weight of the semiconductor wafer 100 is concentrated on the wafer holder 25. The concentrated weight is transferred to the complementary wafer loading boat 10, and then the second weight sensor 63 transfers an increase in the weight in type of electrical signal to the space control part 67. The space control part 67 compares the signal indicating the increase in the weight to the setting point and drives the boat lifting driver 65 to move downwardly the wafer holder 25 at a predetermined height. Thus, the space between the wafer holder 25 and the wafer supporter 21a increases, and the weight loaded to the wafer holder 25 is distributed to the wafer supporter 21a. Therefore, the weight sensed by the second weight sensor 63 of the complementary wafer loading boat 10 is reduced. Accordingly, the weight loaded to the wafer holder 25 by the semiconductor wafer 100 and the contact area of the semiconductor wafer 100 with the wafer holder 25 is maintained constantly by repeating dynamically operations described above during the thermal process. When the thermal process is completed, and the temperature is lowered, spacing control operations are performed reversely to the above operations. That is, when the temperature is lowered, the semiconductor wafer 100 is shrunk, and the semiconductor wafer 100, which is curved at a high temperature, is planarized again. Thus, the weight loaded to the wafer holder 25 is reduced. Then, the first and the second weight sensors 61 and 63 sense the change in the weight, and the space control part 67 controls the boat lifting driver 65 to lift the wafer holder 25. Thus, the weight has controlled at the setting point.

As described above, in the semiconductor manufacturing system according to the present invention, the wafer loading boat 20 or the complementary wafer loading boat 10 are lifted up and down dynamically, so that the contact area of the semiconductor wafer 100 with the wafer holder 25 is maintained constantly. Thus, any defect due to curving of the semiconductor wafer 100 can be minimized, and planarity of the semiconductor wafer 100 can be greatly improved.

In the semiconductor manufacturing system, the complementary wafer loading boat 10 may not be a cylindrical shape and may be formed to support the wafer holder 25 in the semiconductor wafer 100. That is, two complementary supporting pillars 11 may be arranged in parallel with each other, and the wafer holder 25 may be rested on the complementary supporting pillars 11. Thus, the change in the weight due to curving of the semiconductor wafer 100 can be sensed to control the space between the semiconductor Wafer 100 and the wafer holder 25. Then, the complementary supporting pillars 11 and the supporting pillars 21 can be easily arranged, and a structure of the complementary wafer loading boat 10 can be simpler due to a small number of complementary supporting pillars 11. Here, the wafer holder 25 can be fixed in the complementary supporting pillars 11.

In the present invention, the first and the second weight sensors 61 and 63 of the spacing controlling system 60 are included in both the wafer loading boat 20 and the complementary wafer loading boat 10. However, the first and the second weight sensors 61 and 63 can be either the wafer loading boat 20 or the complementary wafer loading boat 10. In addition, an electric pendulum valence can be used to sense the change in the weight and control the wafer loading boat 20 and the complementary wafer loading boat 10. That is, a pendulum structure can be included between the wafer loading boat 20 and the complementary wafer loading boat 10 so as to keep a balance between the weights of the wafer loading boat 20 or the complementary wafer loading boat 10 by controlling them.

In addition, in the present invention, the space between the semiconductor wafer 100 and the wafer holder 25 is controlled by moving either the wafer loading boat 20 or the complementary wafer loading boat 10. However, the space can be controlled by moving both the wafer loading boat 20 and the complementary wafer loading boat 10. For this, the boat lifting driver 65 has to be included in both the wafer loading boat 20 and the complementary wafer loading boat 10. Thus, fine controlling the space can be easily achieved.

In addition, the wafer holder 25 is sufficiently supported by the semiconductor wafer 100 in the present invention. However, when the semiconductor wafer 100 is loaded, the wafer holder 25 and the semiconductor wafer 100 can be loaded with being separated from each other at a predetermined distance considering curving at a high temperature.

As described above, the semiconductor manufacturing system according to the present invention maintains the contact area of the semiconductor wafer with the wafer holder constantly, thereby preventing the semiconductor wafer from being curved during the thermal process at a high temperature.

In addition, any physical defect in the semiconductor wafer can be reduced by maintaining the contact area of the lower portion of the semiconductor wafer with the wafer holder constantly.

Further, the space between the semiconductor wafer and the wafer holder can be controlled, so that the semiconductor wafer can be loaded in various manners so as to prevent any defect in the semiconductor wafer according to a process.

While this invention has been particularly described with reference to preferred embodiments thereof, it will be understood by those skilled in the art that various changes in form and details may be made therein without departing from the spirit and scope of the invention as defined by the appended claims and equivalents thereof.

What is claimed is:

1. A semiconductor manufacturing system having a reaction tube capable of performing a thermal process, the system comprising:
a wafer loading boat, which is mounted in the reaction tube, forms an accommodating space in a shape of a cylinder, and includes a plurality of wafer supporters on which the semiconductor wafer is rested,
a complementary wafer loading boat which is located inside or outside of the wafer loading boat within the reaction tube, includes a wafer holder supporter on which the wafer holder is rested on, where the wafer holder is devised to support the semiconductor wafer with at least a part of area in the middle of the wafer holder, where the wafer holder contacts the semiconductor wafer either at room temperature before processing or during high temperature processing, where the contact between the wafer and the holder at high temperatures can be achieved naturally by placing the wafer holder adjacent to the wafer beneath at room temperature when the semiconductor wafer bows within the elastic limit at high processing temperatures, and transfers a weight loaded to the wafer to its lower portion of the wafer holder,
a door assembly which supports lower portions of the wafer loading boat and the complementary wafer loading boat, moves the wafer loading boat and the complementary wafer loading boat, and closes the reaction tube; and
a spacing controlling system which is mounted in the door assembly, controls a space between the wafer loading boat and the complementary loading boat, which eventually controls the spacing between the semiconductor wafer and the wafer holder, maintains a contact area of the semiconductor wafer with the wafer holder, and dynamically controls the gap between the wafer and holder during thermal processing.

2. The system of claim 1, wherein the wafer loading boat comprises:
a plurality of supporting pillars which are arranged in parallel with each other to form an accommodating space in a shape of a cylinder;
an upper board and a lower board which respectively fixes the supporting pillars at the same level; and
a wafer supporter which is formed in the supporting pillars at a vertical interval and on which the semiconductor wafer is loaded horizontally.

3. The system of claim 2, wherein one sidewall of the supporting pillars is opened, and the number of the supporting pillars is at least one forming a cylindrical shape.

4. The system of claim 3, wherein a section of the supporting pillars has a polygonal shape.

5. The system of claim 2, wherein the wafer supporter is a protrusion protruded at a right angle with respect to the supporting pillars.

6. The system of claim 2, wherein the wafer supporter is a slot formed by grooving the supporting pillars.

7. The system of claim 1, wherein the complementary wafer loading boat comprises:
a plurality of complementary supporting pillars which are arranged at a predetermined interval to form an accommodating space in a shape of a cylinder inside or outside the wafer loading boat; and
a wafer holder which is extended from the complementary supporting pillars to support the semiconductor wafer by making contact with at least a part other than edges of the semiconductor wafer.

8. The system of claim 7, wherein the wafer holder is devised to contact a part of semiconductor wafer, and loaded in the complementary wafer loading boat, does not contact the wafer at room temperature before processing and leaves a certain gap between the wafer and the holder,
a wafer holder which is loaded in the complementary wafer loading boat, touches the wafer at high temperatures during actual processing spontaneously due to the warping and bowing of the wafer within the elastic limit.

9. The system of claim 7, wherein the number of the complementary supporting pillars is at least one supporting pillar to form a cylindrical space.

10. The system of claim 7, wherein the wafer holder has a shape of a plate on which the semiconductor wafer is rested, and the holder supporter is formed in the complementary supporting pillars to load the wafer holder horizontally at a vertical interval.

11. The system of claim 7, wherein the surface of the wafer holder has grooved or protruded shape patterns, which are additionally processed from a simple plate shape.

12. The system of claim 7, wherein the wafer holder includes a plurality of opening portions which are extended from the edge of the wafer holder toward a center of the wafer holder at a predetermined length and shape.

13. The system of claim 7, wherein the holder supporter is a slot formed by grooving the complementary supporting pillars.

14. The system of claim 7, wherein the holder supporter is a protrusion type protruded from the complementary supporting pillars toward the accommodating space of the complementary wafer loading boat.

15. The system of claim 1, wherein the spacing controlling system comprises:
at least one weight sensor which supports at least one of the lower portion of the wafer loading boat and the complementary wafer loading boat and senses a weight of any one of the two wafer loading boats;
a boat lifting driver which is connected to at least either the wafer loading boat or the complementary wafer loading boat and lifts or moves vertically the wafer loading boat connected to the boat lifting driver; and
a space control part which is connected to the weight sensor, compares the sensed weight to a setting point and controls the boat lifting driver.

16. The system of claim 15, wherein the weight sensor is formed by using piezoelectric devices.

17. The system of claim 15, wherein the boat lifting driver moves electrically by a method of fine controlling of a motor.

18. The system of claim 15, wherein the boat lifting driver moves hydraulically by a fluid pressure.

19. The system of claim 15, wherein the weight sensor and the boat lifting driver are electrically connected in series in the space control part.

20. The system of claim 15, wherein the optimum process of the space control system is the dynamic control of the gap between the wafer and holder to eliminate any mechanical damage to the semiconductor wafer, and
the optimum process involves sensing of the weight of either one or two of the loading boats to recognize the point of contact between the wafer and the holder at high temperatures, the feedback of the weight data to control system to optimize the gap dynamically during the thermal processing to eliminate mechanical damages to the semiconductor wafer and uses the warp and bow of the semiconductor wafer at high temperatures to rest the wafer spontaneously on the wafer holder which was originally located beneath the wafer by a gap.
